(19) United States
(12) Patent Application Publication
(10) Pub. No.: US 2015/0304242 A1
(43) Pub. Date: Oct. 22, 2015

(54) DYNAMIC INFORMATION SERVICE METHOD AND SYSTEM

(71) Applicant: Amber Road, Inc., East Rutherford, NJ (US)

(72) Inventor: Kae-por CHANG, Palo Alto, CA (US)

(73) Assignee: Amber Road, Inc., East Rutherford, NJ (US)

(21) Appl. No.: 14/254,091

(22) Filed: Apr. 16, 2014

(51) Int. Cl. H04L 12/927; H04L 29/08

(52) U.S. Cl. CPC H04L 47/808; H04L 67/306

(57) ABSTRACT

A system, method, and computer-readable storage medium configured to access computing resources and functions in a computer network based on organization hierarchy and geographic provisioning.

### BACKGROUND

1. Field of the Invention

Aspects of the disclosure relate in general to computer science. Aspects include an apparatus, a method and system to access computing resources and functions in a computer network based on self-defined provisioning structure among organization units such as business and/or geographic hierarchy on a dynamic basis as the authorization scope may change from time to time.

2. Description of the Related Art

In an age where an increasing number of computing resources are virtual (i.e., “put into the cloud”), provisioning resources between related entities is a difficult task. Typically, multi-national corporations organize themselves on either geography or by business function and assign their computing resources by organization. For example, a multi-national corporation may have multiple business units running their business around the globe while having subsidiaries in the United States, China, and India to provide certain corporate functions across business units within the region.

### SUMMARY

Embodiments include a system, device, method and computer-readable medium to access to computing resources and functions in a computer network based on self-defined dynamic provisioning structure among organization units.

In one embodiment, a system has a network interface and a processor. The network interface receives a function request from a computing device. The function request is associated with a user account and indicating application program to be executed. The processor uses the user account to retrieve employee information from a database. The employee information includes a business entity associated with an employee. The processor a function specific provision organization list specified for the business entity which the user belongs to gain access to functions or data in order to perform operations for business entities on the list. The processor determines whether the user account may access the application program based on the business entity associated with the employee, and the function provision organization. The processor executes the application program when it determines the user account may access the program.

### BRIEF DESCRIPTION OF THE DRAWINGS

FIG. 1 illustrates an organizational hierarchy based on geography, supported by an embodiment.

FIG. 2 depicts an organizational hierarchy based on business function, supported by an embodiment.

FIG. 3 illustrates a system to access computing resources and functions in a computer network based on organization hierarchy and geographic provisioning.

FIG. 4 is an expanded block diagram of an exemplary embodiment of a server architecture to access computing resources and functions in a computer network based on organization hierarchy and geographic provisioning.

FIG. 5 is a flowchart of a method to access computing resources and functions in a computer network based on organization hierarchy and geographic provisioning.

FIG. 6 illustrates an example function provision organization table embodiment used to access computing resources and functions in a computer network based on organization hierarchy and geographic provisioning.

### DETAILED DESCRIPTION

One aspect of the disclosure includes the realization that large multi-national corporations increasingly organize themselves using both geographically and by business type. As a result, standard ways of partitioning computing instructions and computing resources between business entities using business functions or geographic provisioning are inadequate. For example, when applied to operational and reporting functions, a single uniform hierarchical structure may be inadequate in representing actual business and functional operations. Embodiments move beyond typical organizational structures, and enable the provisioning of operational and reporting functions to reflect actual business operations by function or group of functions, which can evolve in the future.

In another aspect of the disclosure, each function may be apportioned resources on a business or geographic basis. In addition, even with a business or geographic apportion, the provisioning among organization units may be different as some functions could be more centralized than others. For instance, a centralized corporate function such as product classification may be done by the one and only one team in a country while other centralized corporate functions such as import and export can be done by regional teams in a country. Furthermore, the scope of apportioned resource may change as the corporation continues to evolve and enhance its operations.

While embodiments described herein are applied to the allocation of functionality via business function and geographic provisioning, it is understood by those familiar with the art that the concepts, apparatus, system and methods described herein may also be applicable to other forms of business organization.

The systems and processes are not limited to the specific embodiments described herein. In addition, components of each system and each process can be practiced independently and separately from other components and processes described herein. Each component and process also can be used in combination with other assembly packages and processes.

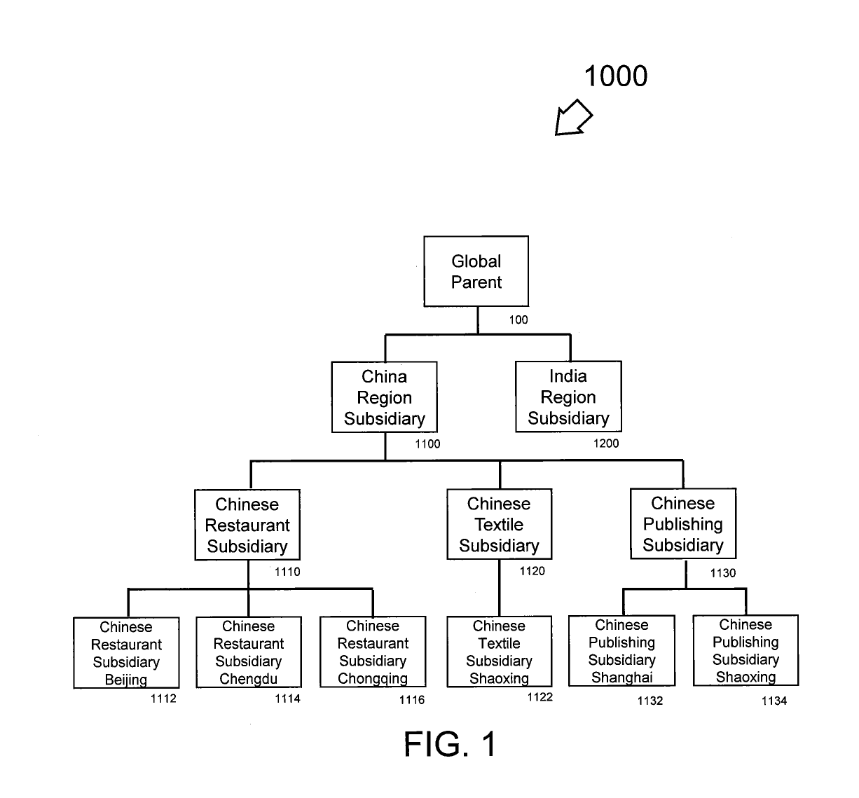

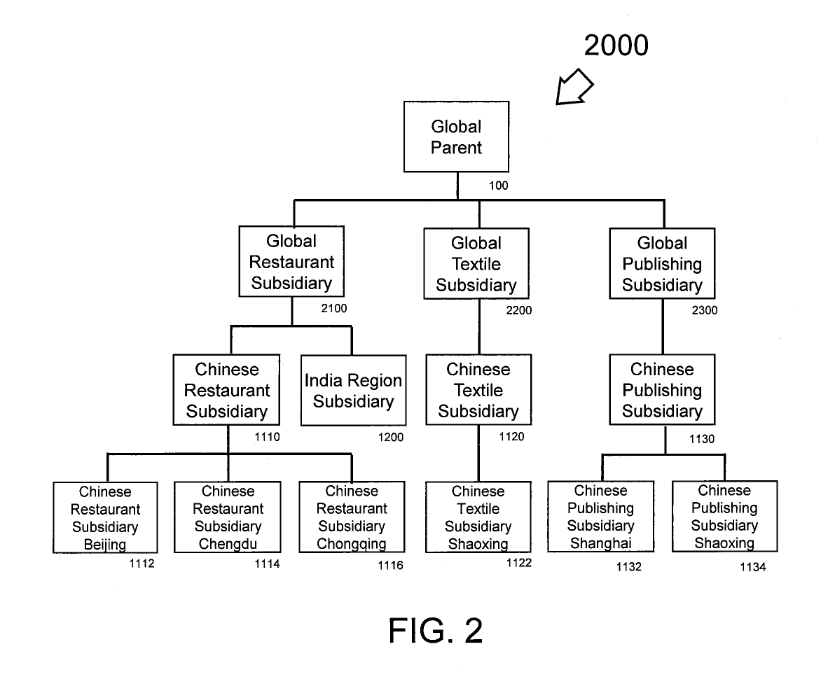

We now turn our attention to exemplary organizational structures supported by embodiments of the present disclosure, FIGS. 1-2. It is understood by those skilled in the art that other equivalent organizational structures can exist and may be supported by embodiments of the present disclosure without departing from the spirit or claims of the invention.

FIG. 1 illustrates an organizational hierarchy 1000 primarily based on geography, constructed and operative in accordance with an embodiment of the present disclosure. In this example, a global parent company 100 has a China region subsidiary 1100 and an India region subsidiary 1200. The China region subsidiary 1100 may also have subsidiaries in various lines of business. For example, the China region subsidiary 1100 may operate in the restaurant, textile, and publishing industries, and have corresponding subsidiaries: a Chinese restaurant subsidiary 1110, a Chinese textile subsidiary 1120, and a Chinese publishing subsidiary 1130. In turn, each of these Chinese business subsidiaries 1110-1130 may have their own subsidiaries for each city they have a presence. Chinese restaurant subsidiary 1110 may have individual subsidiaries in Beijing 1112, Chengdu 1114, and Chongqing 11116. Chinese textile subsidiary 1120 may have a subsidiary in Shaoxing 1122. Chinese publishing subsidiary 1130 may have a subsidiaries in Shanghai 1132 and Shaoxing 1134.

FIG. 2 depicts an organizational hierarchy 2000 based primarily on business function, constructed and operative in accordance with an embodiment of the present disclosure. In this example, the global parent company 100 has a global restaurant subsidiary 2100, a global textile subsidiary 2200, and a global publishing subsidiary 2300.

The global subsidiaries 2100-2300 may also have subsidiaries in each operating region. For example, the global restaurant subsidiary 2100 may operate in China and India, and have corresponding subsidiaries: a Chinese restaurant subsidiary 1110 and an India region subsidiary 1200. The global textile subsidiary 2200 may have a Chinese textile subsidiary 1120. The global publishing subsidiary 2300 may have a Chinese publishing subsidiary 1130.

In turn, each of these Chinese business subsidiaries 1110-1130 may have their own subsidiaries for each city they have a presence. Chinese restaurant subsidiary 1110 may have individual subsidiaries in Beijing 1112, Chengdu 1114, and Chongqing 11116. Chinese textile subsidiary 1120 may have a subsidiary in Shaoxing 1122, while Chinese publishing subsidiary 1130 may have subsidiaries in Shanghai 1132 and Shaoxing 1134.

When comparing the two organizational structures of FIGS. 1-2, it is readily apparent that the organizational structures reflect mutually exclusive decisions between business and geographic options. With respect to the primarily geographical structure illustrated in FIG. 1, there is no indication how the global restaurant subsidiary 2100, global textile subsidiary 2200, or global publishing subsidiary 2300 relate and manage their global businesses. Similarly, with the primarily business function structure illustrated in FIG. 2, there is no true indication how the China region subsidiary 1100 or India Region Subsidiary 1200 operate in their regions. Embodiments of the disclosure are able to logically traverse the geographic structures of FIGS. 1-2 and facilitate the access control of functionality and data based on the actual

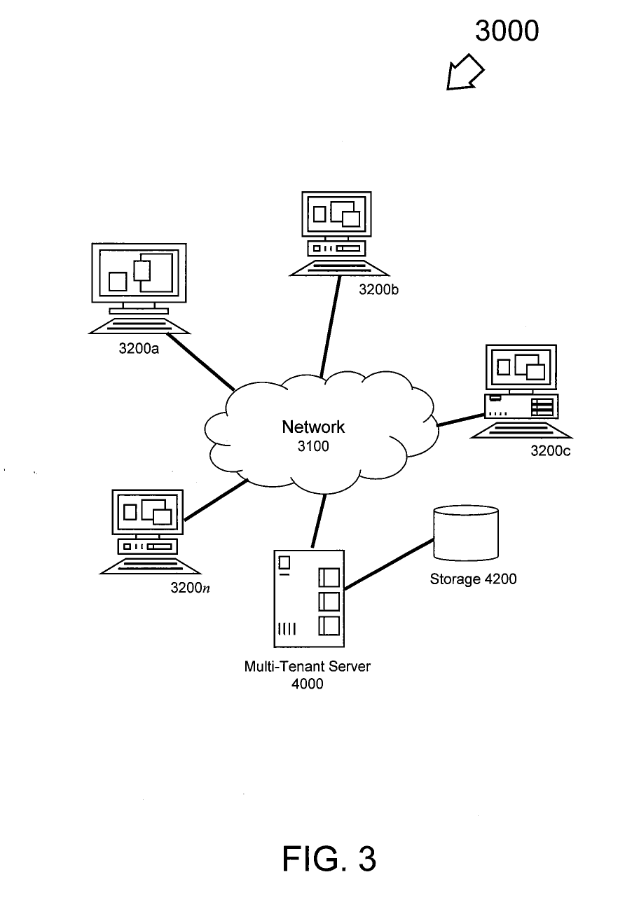

FIG. 3 illustrates a system 3000 to access computing resources and functions in a computer network based on organization hierarchy and geographic provisioning, constructed and operative in accordance with an embodiment of the present disclosure. In system 3000, multiple network-enabled computing devices 3200a-n are located at the various corporate entities such as global parent 100, regional subsidiaries 1100-1200, global business subsidiaries 2100-2300, Chinese business subsidiaries 1110-1130, or subsidiaries located at each location 1112-1134.

Computing devices 3200 allow employees of the various business entities to communicate with a multi-tenant server 4000 that implements business applications and accesses/stores data for the various business entities. Computing devices 3200 include personal computers, laptop computers, tablet devices, mobile telephones or any network-capable computing devices known in the art capable of communicating to with multi-tenant server 4000. It is understood that computing devices 3200a-n communicate with a multi-tenant server 4000 over a network 3100. It is further understood that computing devices 3200a-n may have a display to communicate between the multi-tenant server 4000 and a user using the computing device 3200.

Network 3100 may be any computer communications network known in the art. It is understood that that some business entities may configure network 3100 as an intranet, limiting the use of the intranet to its authorized users. In other embodiments, the business entity may use an Wide Area Network (WAN) internetwork such as the Internet.

In embodiments of the current disclosure, multi-tenant server 4000 is able to provision access to applications and data based on organization hierarchy and business geography. As will be described below, provisioning access to applications and data based on organization hierarchy and geography enable employees of various business entities to conduct their duties while ensuring data security.

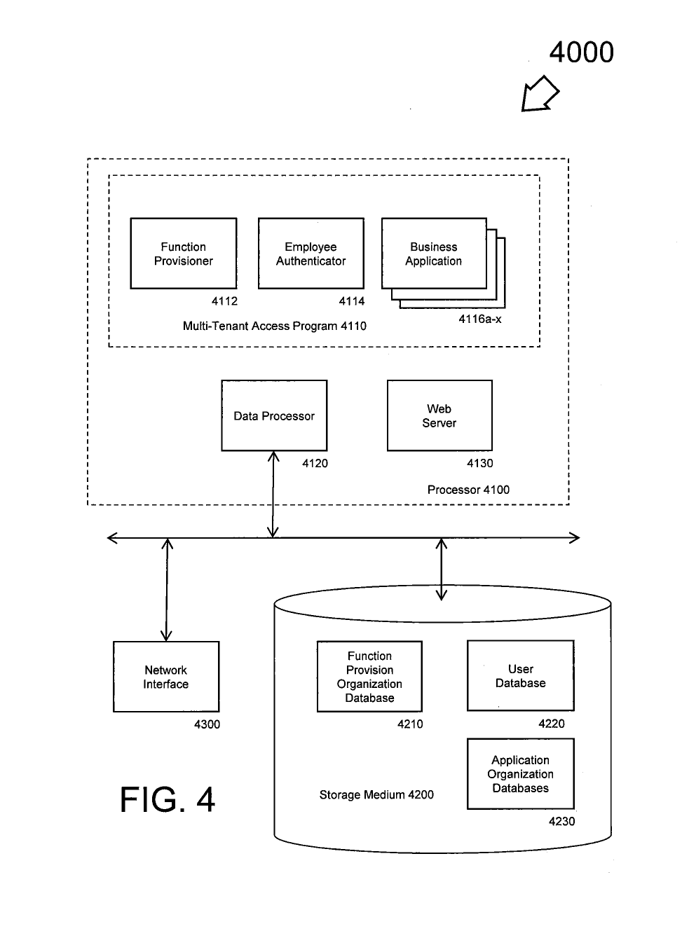

Embodiments will now be disclosed with reference to a block diagram of an exemplary multi-tenant server 4000 of FIG. 4, configured to access computing resources and functions in a computer network based on organization hierarchy and geographic provisioning, constructed and operative in accordance with an embodiment of the present disclosure.

Multi-tenant server 4000 may run a multi-tasking operating system (OS) and include at least one processor or central processing unit (CPU) 4100, a non-transitory computer-readable storage medium 4200, and a network interface 4300.

Processor 4100 may be any central processing unit, microprocessor, micro-controller, computational device or circuit known in the art.

As shown in FIG. 4, processor 4100 is functionally comprised of a multi-tenant access program 4110, a World-Wide-Web interface 4130, and a data processor 4120.

Data processor 4120 interfaces with storage medium 4200 and network interface 4300. The data processor 4120 enables processor 4100 to locate data on, read data from, and writes data to, these components.

Web server 4130 is any computing device configured to deliver web pages or other content across network 3100 via network interface 4300; computing devices 3200 may communicate with the multi-tenant access server 4000 via the World-Wide-Web protocol and web-server 4130.

Multi-tenant access program 4110 is the structure that enables users of computing device 3200 to execute business applications and access business data based on organization hierarchy and geographic provisioning, and may further comprise: a function provisioner 4112, user database 4114, and business applications 4116a-x.

User authenticator 4114 identifies and/or authenticates users of computing device 3200, and may do so in conjunction with an user database 4220. In authenticating users, user authenticator 4114 may use passwords, passkeys, data tokens, biometric identification, two-factor authentication, or any other form of identity authentication known in the art stored in user database 4220. As part of the user identification, user authenticator 4114 may also identify the geographic location, and the business entity or entities that the employee user is associated with.

Additionally, multi-tenant access program 4110 may have a plurality of business applications 4116a-x that are specific to the businesses and processes for each business entity. Business applications may include, but are not limited to: product management, supply chain management, production, distribution, inventory control, shipment tracking, trade compliance, certificates and permits, preferential trade programs, shipment declaration and clearance, equipment , performance measurements and Key Performance Indicator (KPI) reporting and analysis, taxes, expenses, document management, or any other business application known in the art. Business applications 4116 may operate in conjunction with application organization databases 4230.

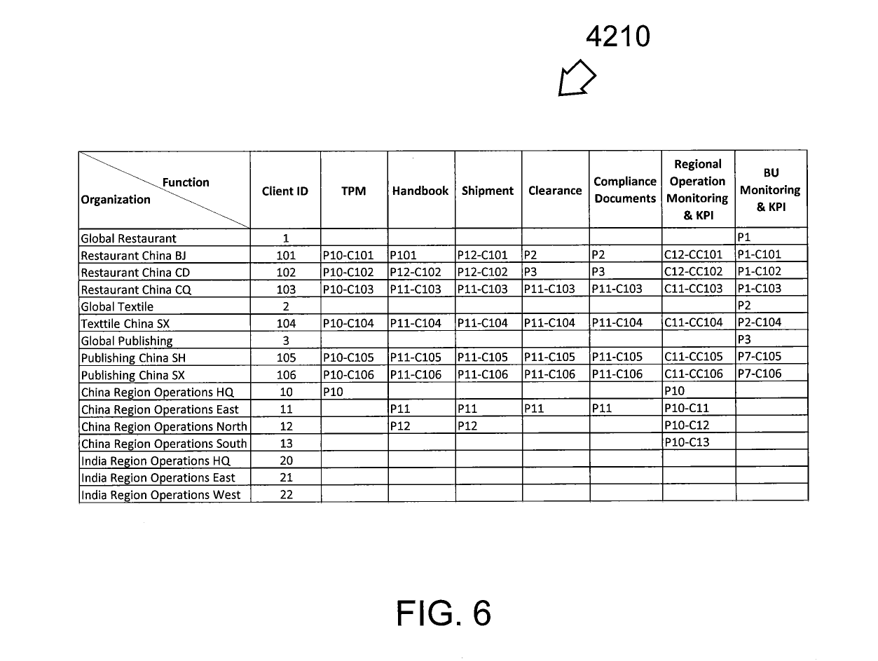

Function provisioner 4112 analyzes user information and provisions access to business applications and data stored in application organization databases 4230 based on a function provision organization database 4210. An example function provision organization database 4210 is shown in FIG. 6.

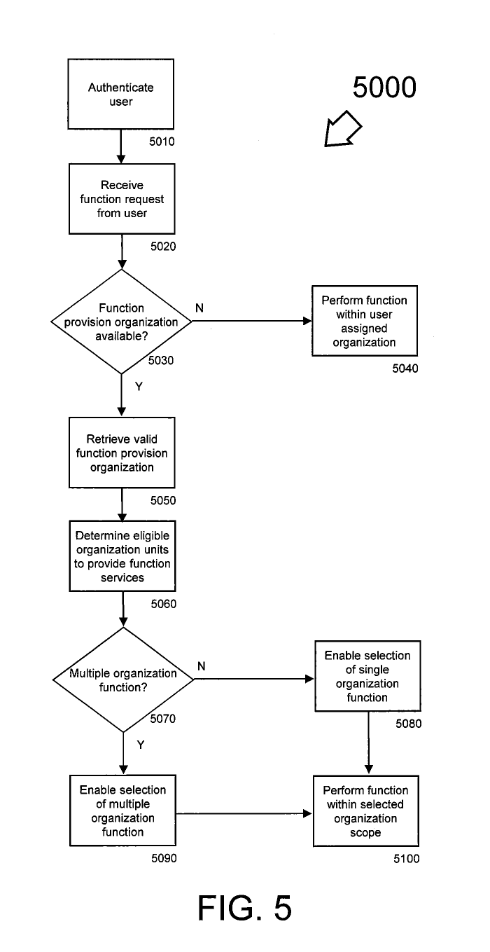

The functionality of all the multi-tenant access program 4110 structures is elaborated in greater detail in FIG. 5.

These structures may be implemented as hardware, firmware, or software encoded on a computer readable medium, such as storage medium 4200. Further details of these components are described with their relation to method embodiments below.

Computer-readable storage medium 4200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 4200 may be remotely located from processor 4100, and be connected to processor 4100 via a network such as a local area network (LAN), a wide area network (WAN), or the Internet.

In addition, as shown in FIG. 4, storage medium 4200 may also contain a function provision organization database 4210, employee user database 4220 and application organization databases 4230. It is understood by those familiar with the art that one or more of these databases 4210-4230 may be combined in a myriad of combinations. Furthermore, while in some embodiments, the various databases 4210-4230 are relational databases, it is understood by those familiar with the art that the data may equally be stored in a variety of different data structures, including, but not limited to: flat files, arrays, records, linked lists, tables, graphs, object-oriented data fields, or any other data structure known in the art.

Network interface 4300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 4300 allows multi-tenant server 4000 to computing devices 3200.

We now turn our attention to method or process embodiments of the present disclosure, FIG. 5. It is understood by those known in the art that instructions for such method embodiments may be stored on their respective computer-readable memory and executed by their respective processors. It is understood by those skilled in the art that other equivalent implementations can exist without departing from the spirit or claims of the invention.

Embodiments provision user access to computing resources and data, such as business applications 4116 and application organization databases 4230, based on business organization and geography. FIG. 5 is a flowchart of a process 5000 to access computing resources and functions in a computer network based on organization hierarchy and geographic provisioning, constructed and operative in accordance with an embodiment of the present disclosure.

At block 5010, user authenticator 4114 receives user authentication data from computing device 3200. The authentication data is received electronically via a network interface 4300. In some embodiments, the authentication data is conveyed by the network interface 4300 through the web server 4130. In some embodiments, the authentication data is compared with pre-existing data stored within user database 4220. User database 4220 may contain pre-existing authentication information, such as passwords, passkeys and the like. Additionally, user database 4220 contains user/employee information such as the business entity and geography associated with the user.

Once the user is authenticated, multi-tenant access program 4110 knows the user, the business entity and geography associated with the user from user database 4220. If the user is not authenticated, they will not be given access to the multi-tenant access server 4000.

The function provisioner 4112 receives a function request to access a business application 4116 or data within application organization database 4230, block 5020. A function request is a request to use a business application 4116.

Function provisioner 4112 checks to see if the user or business entity has an entry within function provision organization database 4210, at decision block 5030. The provision organization relationships can be among the organization entity of the user or directly the user and the organizations on which the user can perform the function.

If no applicable entry within function provision organization database 4210 exists, as determined at decision block 5030, the user is permitted to perform the function/business application only within their assigned user organization, block 5040.

If an applicable entry within function provision organization database 4210 is found, as determined at decision block 5030, function provisioner 4112 retrieves the valid function provision organization. Note that function provision organizations may have an associated time/date of validity. For example, certain functions may be seasonal, and allocated to certain business entities in the first and second quarters (“Q1” and “Q2”) of the year. A corresponding function provision organization would be valid in those quarters, while a different function provision organization would be valid during the third and fourth quarters (“Q3” and “Q4”).

At block 5060, the function provisioner 4112 determines which organization units are eligible to provide the particular business application 4116. For example, suppose the employee user is associated with the Chinese restaurant subsidiary 1110. As shown in FIG. 6, Chinese restaurant subsidiary 1110 employees only have access to a business unit monitoring 86 KPI business application 4116 and data for its subsidiaries, and no other business applications—even if those business applications are accessible by their own subsidiaries.

If the selected business application is a multiple organization function (i.e. has a multiple organization scope), as determined at block 5070, the multiple organization function is enabled at block 5090. The process continues at block 5100.

If the selected business application is a single organization function (i.e. has a single organization scope), as determined at block 5070, the single organization function is enabled at block 5090. The process continues at block 5100.

At block 5100, the function is performed within the selected organization scope.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving, via a network interface, a function request from a computing device, the function request associated with a user account and indicating an application program to be executed;
using the user account to retrieve user information from a database with a processor, the user information including a business entity associated with an employee;
retrieving a function provision organization with the processor, the function provision organization specifying access to functions or data in order to perform operations for business entities on the list by the user or by the business unit to which the user is assigned;
determining, with the processor, whether the user account may access the application program to be executed based on the business entity associated with the employee and the function provision organization;
executing the application program when the processor determines the user account may access the program.

2. The method of claim 1, further comprising:
authenticating the user account with the employee information from the database.

3. The method of claim 2, further comprising:
permitting data access to the application program based at least in part on the business entity associated with the user.

4. The method of claim 2, further comprising:
permitting data access to the application program based at least in part on the business entity and geographic location associated with the user.

5. The method of claim 4, wherein the application program is product management, supply chain management, production, distribution, inventory control, shipment tracking, trade compliance, certificates and permits, preferential trade programs, shipment declaration and clearance, equipment , performance measurements and Key Performance Indicator (KPI) reporting and analysis, taxes, expenses, or document management.

6. The method of claim 5, further comprising:
displaying the application program on a display.

7. A system comprising:
a network interface configured to receive a function request from a computing device, the function request associated with a user account and indicating an application program to be executed;
a processor configured to use the user account to retrieve user information from a database, the user information including a business entity associated with a user, to retrieve a function provision organization, the function provision organization specifying access to functions or data based on business entity and geographic location, to determine whether the user account may access the application program to be executed based on the business entity associated with the user or the user account directly and the function provision organization, and to execute the application program when the processor determines the user account may access the program.

8. The system of claim 7, wherein the processor is further configured to authenticate the user account with the user information from the database.

9. The system of claim 8, wherein the processor is further configured to permit data access to the application program based at least in part on the business entity associated with the user.

10. The system of claim 9, wherein the processor is further configured to permit data access to the application program based at least in part on the geographic location associated with the employee.

11. The system of claim 9, wherein the processor is further configured to permit data access to the application program based at least in part on the business entity and geographic location associated with the user.

12. The system of claim 11, wherein the application program is inventory tracking, or shipment tracking.

13. The system of claim 12, further comprising:
a display configured to display the application program.

14. A non-transitory computer readable medium encoded with data and instructions, when executed by a computing device the instructions causing the computing device to:
receive, via a network interface, a function request from a computing device, the function request associated with a user account and indicating an application program to be executed;
use the user account to retrieve employee information from a database with a processor, the employee information including a business entity associated with an employee;
retrieve a function provision organization with the processor, the function provision organization specifying access to functions or data based on business entity and geographic location;
determine, with the processor, whether the user account may access the application program to be executed based on the business entity associated with the employee, and the function provision organization;
execute the application program when the processor determines the user account may access the program.

15. The non-transitory computer readable medium of claim 14, further comprising:
authenticate the user account with the employee information from the database.

16. The non-transitory computer readable medium of claim 15, further comprising:
permit data access to the application program based at least in part on the business entity associated with the employee.

17. The non-transitory computer readable medium of claim 16, further comprising:
permit data access to the application program based at least in part on the business entity and geographic location associated with the employee.

18. The non-transitory computer readable medium of claim 17, wherein the application program is product management, supply chain management, production, distribution, inventory control, shipment tracking, trade compliance, certificates and permits, preferential trade programs, shipment declaration and clearance, equipment , performance measurements and Key Performance Indicator (KPI) reporting and analysis, taxes, expenses, or document management.
